(19) United States
(12) Patent Application Publication
(10) Pub. No.: US 2017/0034216 A1
(43) Pub. Date: Feb. 2, 2017

(54) AUTHORIZING APPLICATION ACCESS TO VIRTUAL PRIVATE NETWORK RESOURCE

(71) Applicant: Hewlett Packard Enterprise Development LP, Houston, TX (US)

(72) Inventors: Soma Sundaram Santhiveeran, Sunnyvale, CA (US); Jose Paulo Xavier Pires, Rio Grande do Sul (BR); Humberto Cardoso Marchezi, Rio Grande do Sul (BR); Paul Gerhard Schulze, Rio Grande do Sul (BR); Ricardo Moreira, Rio Grande do Sul (BR)

(73) Assignee: Hewlett Packard Enterprise Development LP, Houston, TX (US)

(21) Appl. No.: 15/100,007

(22) PCT Filed: Nov. 27, 2013
(86) PCT No.: PCT/US2013/072267

§ 371 Date: May 27, 2016

(51) Int. Cl. H04L 29/06

(52) U.S. Cl. CPC H04L 63/20; H04L 63/0272; H04L 63/08; H04L 63/101

(57) ABSTRACT

Examples of authorizing application access to a virtual private network are disclosed. In one example implementation according to aspects of the present disclosure, a method may include connecting, by a computing system, electronically to a virtual private network (VPN) by sending authentication credentials, and receiving, by the computing system, a set of application policies from an application policy database in the VPN. The method may further include determining, by the computing system, whether an application running on the computing system is authorized to access resources within the VPN based on the set of application policies received from the application policy database. Additionally, the method may include enabling, by the computing system, the application to access the resources within the VPN when it is determined that the set of application policies authorizes the application to access the resources within the VPN.

### BACKGROUND

Computing devices such as smart phones, tablets, laptops, etc. have become more common for both personal and business purposes. The users of these devices have begun using their personal mobile devices to access personal information as well as business data that may reside on corporate enterprises. For example, a user may access his personal email and his corporate email on the same computing device.

### BRIEF DESCRIPTION OF THE DRAWINGS

The following detailed description references the drawings, in which:

FIG. 1 illustrates a block diagram of a virtual private network that uses application policies to authorize application access to a virtual private network resource from client devices according to examples of the present disclosure;

FIG. 2 illustrates a block diagram of a computing system that uses application policies to authorize application access to a virtual private network resource according to examples of the present disclosure;

FIG. 3 illustrates a block diagram of a computing system that uses application policies to authorize application access to a virtual private network resource according to examples of the present disclosure;

FIG. 4 illustrates a flow diagram of a method for using application policies to authorize application access to a virtual private network resource according to examples of the present disclosure; and

FIG. 5 illustrates a flow diagram of a method for using application policies to authorize application access to a virtual private network resource according to examples of the present disclosure.

### DETAILED DESCRIPTION

In the consumer information technology environment, users frequently use both enterprise applications along with consumer applications from or on their computing devices. For example, a user may desire to access both personal and corporate email from the same device. Similarly, a user may use enterprise applications for performing work functions from the same device they use personally to access social networks.

The enterprise applications may reside on in a corporate enterprise environment behind an enterprise firewall, requiring enhanced security and authorization. In contrast, the consumer applications usually need only basic Internet access to function.

Most enterprise applications, legacy client-server applications and emerging HTML5 applications use a virtual private network (VPN) to connect client-side applications on the user's device to the server-side applications inside the enterprise firewall. Once a VPN connection is established, enterprise assets inside the corporate enterprise firewall are accessible to the applications running on the device—both applications authorized by the enterprises as well as those downloaded from the public Internet, which may be harmful or dangerous to the enterprise resources. This allows, for example, a malicious application downloaded from the Internet or accessed through a browser, to connect to enterprise assets inside the enterprise firewall, exposing such assets and resources to variety of security risks and dangers.

Current generation VPN technologies allow all applications on the client devices to connect to VPN resources (such as through IP addresses accessible via the VPN). This enables unauthorized applications, including those downloaded from the Internet, to access the VPN assets, increasing security risks. Other solutions utilize client-based agent enforcing the routing policies.

Various embodiments will be described below by referring to several examples of using an application policy for authorizing an application in a virtual private network. An administrator defines the application policy in the enterprise environment that allows application-by-application authorization control. For example, the administrator may selectively limit access to enterprise assets (also referred to as VPN assets or resources) exposed via the VPN to authorized applications while blocking access to other applications (either explicitly or by exclusion). In addition to controlling access by legacy applications, the present disclosure also allows restricting access to web-based applications that run within a browser application, as well as to other applications that run inside virtual machines.

In some implementations, using an application policy for authorizing an application in a virtual private network provides granular control over which applications can access which assets within a VPN. The current solution also works for browser-based applications, native/legacy applications, and virtual machine-based applications alike. Management overhead is minimized by eliminating the need to provision policies in the clients (which can cause extensive overhead as the number of clients increases). Moreover, using an application policy for authorizing an application in a virtual private network is more secure as compared to access control at the client device level because it is performed at the entry point (i.e., VPN server) to the enterprise network. These and other advantages will be apparent from the description that follows.

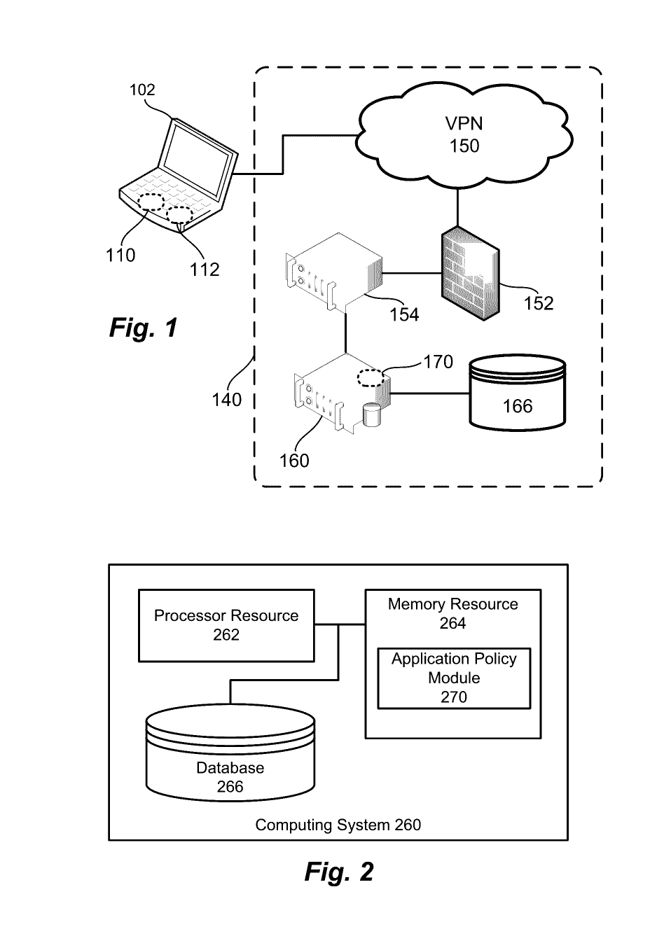

FIG. 1 illustrates a block diagram of a virtual private network that uses application policies to authorize application access to a virtual private network resource from client devices according to examples of the present disclosure. In the example shown, a client device 102 connects to an enterprise network 140 that includes at least a virtual private network (VPN) 150. The VPN 150 may utilize a firewall 152, a VPN authentication device 154, an application policy management device 160, and an application policy database 166 within the enterprise network 140.

The client device 102 may include any suitable type of computing device, including for example smartphones, tablets, desktops, laptops, workstations, servers, smart monitors, smart televisions, digital signage, scientific instruments, retail point of sale devices, video walls, imaging devices, peripherals, or the like. Within the client device 102 may be stored a VPN client 110 and an application policy repository 112. Although not illustrated in FIG. 1, the client device 102 may include an application or set of applications that run natively on the client device 102 or through a browser or virtual machine on the client device 102.

The VPN client 110 of the client device 102 initiates a secure connection to the enterprise network 140 via the VPN 150 and associated devices. Virtual private network 150 represents generally hardware components and computers interconnected by communications channels that allow sharing of resources and information. The VPN 150 may include and/or utilize one or more of a cable, wireless, fiber optic, or remote connection via a telecommunication link, an infrared link, a radio frequency link, or any other connectors or systems that provide electronic communication. The VPN 150 may include and/or utilize, at least in part, an Intranet, the internet, or a combination of both. The VPN 150 may also include intermediate proxies, routers, switches, load balancers, and the like. The paths followed by VPN 150 between client device 102 and firewall 152 (continuing on to VPN server 154 and application policy management device 160) as depicted in FIG. 1 represent the logical communication paths between these devices, not necessarily the physical paths between the devices.

The VPN client 110 of the client device 102 may perform authentication procedures with the VPN authentication device 154, such as sending authentication credentials, which may include a username, a password, a passcode, a unique identifier, and/or other suitable authentication information to the VPN authentication device 154. Once successful authentication occurs between the client device 102 and the VPN authentication device 154, the virtual private network 150 is said to be connected or active. Once successful authentication occurs, the client device 102 can communicate with the enterprise network 140. The firewall 152 may act to prevent unauthorized access to the VPN 150 from devices or applications that are not successfully authenticated by the VPN authentication server 154.

Once the VPN client 110 of the client device 102 is in successful communications with the enterprise network 140 via the VPN 150, applications residing on or being executed by the client device 102 may attempt to access resources of the enterprise network 150. However, for the applications of the client device 102 to be successful in accessing the enterprise network 140, the applications must have authorization to access the resources of the enterprise network 140.

In this case, the application is compared to the application policy stored in the application policy repository 112 of the client device 102. The application policy repository 112 stores the access restrictions on a per application basis. In one example, it may contain a list of authorized applications, and for each application, it may list the virtual private network assets or resources that each application may access. In another example, each application may be identified using a predefined identifier, such as an application code, a numeric code, or other suitable identifier. Each of the listed VPN assets or resources may also be uniquely identified, such as by a URL, an IP address, an IP address and IP port pair, or other suitable identifier.

If an application attempting to access resources of the enterprise network 140 is listed in the application policy repository 112 as an “allowed” application, the firewall 152 may enable the application to access various resources within the enterprise network 140. However, if the application attempting to access resources of the enterprise network 140 is not listed in the application policy repository 112 as an “allowed” application (or if it is explicitly listed as a “denied” application), the firewall 152 may not enable the application to access the resources within the enterprise network 140.

The application policy repository 112 may receive the application policy or policies from the application policy database 166 via the application policy management device 160. For example, upon successful connection to and authentication with the VPN 150, the application policy management device 160 may send to the client device 102 the application policy or policies as defined in the application policy database 166. The application policy or policies may be automatically uploaded to the client device 102 each time the client device 102 connects to the VPN 150, each time the policy or polices are updated in the application policy database 166, each time a new application is installed on the client device 102, or at such other time as is appropriate.

An application policy module 170 of the application policy management device 160 enables an administrative user to upload policies, edit policies, create policy, and otherwise manage policies for applications to selectively access resources of the enterprise network 140. In this way, the application module 170 provisions access restrictions to a set of applications on the client device 102.

FIG. 2 illustrates a block diagram of a computing system that uses application policies to authorize application access to a virtual private network resource according to examples of the present disclosure. It should be understood that the computing system 262 may include any appropriate type of computing device, including for example smartphones, tablets, desktops, laptops, workstations, servers, smart monitors, smart televisions, digital signage, scientific instruments, retail point of sale devices, video walls, imaging devices, peripherals, or the like.

The computing system 260 may include a processing resource 262 that may be configured to process instructions. The instructions may be stored on a non-transitory tangible computer-readable storage medium, such as memory resource 264, or on a separate device (not shown), or on any other type of volatile or non-volatile memory that stores instructions to cause a programmable processor to perform the techniques described herein. Alternatively or additionally, the computing system 260 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

In addition to the processing resource 262 and the memory resource 264, the computing system 260 may include an application policy module 270. In one example, the modules described herein may be a combination of hardware and programming. The programming may be processor executable instructions stored on a tangible memory resource such as memory resource 264, and the hardware may include processing resource 262 for executing those instructions. Thus memory resource 264 can be said to store program instructions that when executed by the processing resource 262 implement the modules described herein. Other modules may also be utilized as will be discussed further below in other examples.

The application policy module 270 may generate an application policy to provision access restrictions to a set of applications in one example. In another example, the application policy module 270 may generate an application policy to provision access restrictions to the set of applications as well as to a set of network resources. In this way, each of the set of applications includes an access designation for each of the set of network resources, such that an application may designate certain resources within the VPN that may be accessed.

The application policy module 270 of the computing system 260 enables an administrative user to upload policies, edit policies, create policies, and otherwise manage policies for applications to selectively access resources of the enterprise network. In this way, the application module 270 provisions access restrictions to a set of applications on the client device. In one example, generating an application policy includes an administrative user of the computing system 260 creating an application policy or set of policies or uploading an application policy or set of policies to the database 266. For example, an administrative user of the computing system 260 may create a list of applications that may access VPN resources within the enterprise network. Each application may be individually associated with particular VPN resources such as with an access designation, or each application may be able to access the same and/or all VPN resources. In one example, the administrative user may determine that certain applications are not suitable for accessing VPN resources and may deny access to the VPN resources from these applications. For instance, social networking applications may be denied access to VPN resources.

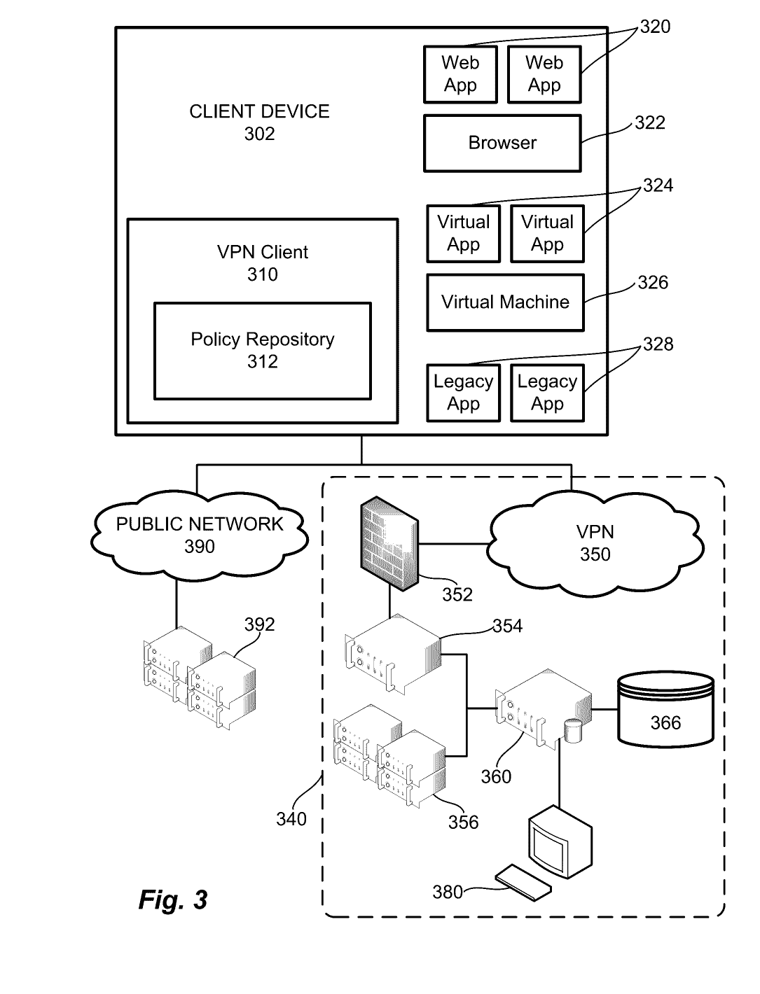

FIG. 3 illustrates a block diagram of a computing system that uses application policies to authorize application access to a virtual private network resource according to examples of the present disclosure. In the example shown, a client device 302 includes a VPN client 310 for establishing a secure connection to an enterprise network 340 and a policy repository 312 for storing application policies. The application policies, which are received from the application policy database 366 of the enterprise network 340, designate which of applications 320, 324, and 328 may access the enterprise network 340 and the enterprise resources 356.

In this example, three different types of applications are shown, although other applications are also possible: web applications 320 that run embedded through a web browser 322 on the client device 302, applications 324 that run through a virtual machine 326 on the client device 302, and legacy applications 328 that run natively on the client device 302. Each of the applications' access to the enterprise network 340 is controlled by the application policy stored in the policy repository 312. For example, the application policy may state that certain legacy applications 328, such as social media applications, personal email applications, games, etc., may not access the enterprise network 340 (and consequently the enterprise resources 356). Instead, these applications are directed to a public network 390 and its associated public servers 392. The public network 390 may include the Internet, a different intranet, or another suitable network different from the enterprise network 340. The application policy may also deny access to the enterprise network 340 for various web applications 322 and/or virtual applications 324.

The policy repository 312 also indicates which applications may access the enterprise network 340 and consequently the enterprise resources 356. For example, a virtual application 324 that runs on a virtual machine 326 on the client device 302 may need access to certain data on the enterprise network 340 to perform allowable functions. In this case, the policy in the policy repository 312 may indicate that the appropriate virtual application 324 may access the enterprise network 340 via the VPN 350 to interact with the enterprise resources 356.

In this example, the client device 302 connects to an enterprise network 340 that includes at least a virtual private network (VPN) 350. The VPN 350 may utilize a firewall 352, a VPN authentication device 354, an application policy management device 360, and an application policy database 366 within the enterprise network 340. The enterprise network 340 also includes enterprise resources 356 and an administrative terminal 380 communicatively coupled to the application policy management device 360. The administrative terminal 380 enables an administrative user to access the application policy management device 360 to administer the policies stored in the application policy database 366. This may include adding application allowances or denials to existing policies, generating new policies, or otherwise modifying existing application policies.

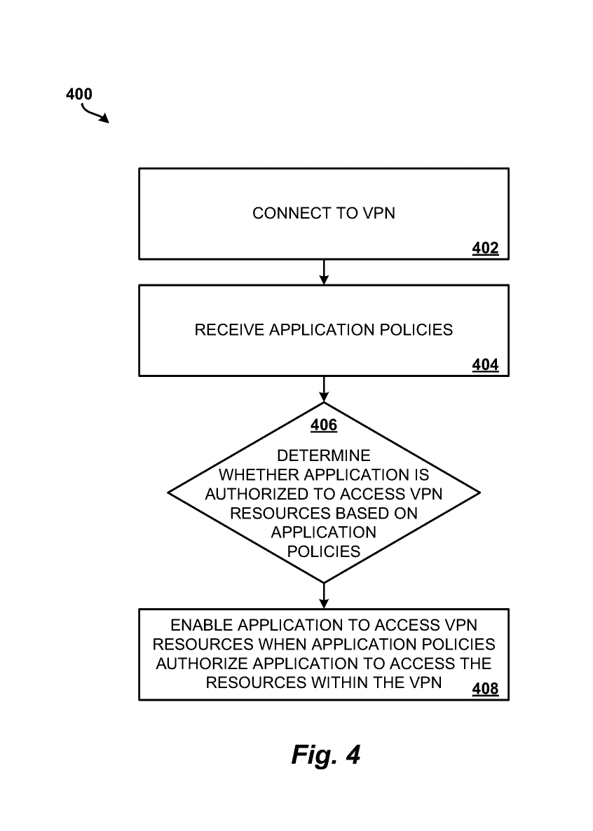

FIG. 4 illustrates a flow diagram of a method 400 for using application policies to authorize application access to a virtual private network resource according to examples of the present disclosure. The method 400 may be executed by a computing system or a computing device such as computing device 102, 202, or 302 of FIGS. 1-3 respectively. In one example, method 400 may include: connecting, by a computing system, electronically to a virtual private network (VPN) (block 402); receiving, by the computing system, a set of application policies from an application policy database within the VPN (block 404); determining, by the computing system, whether an application running on the computing system is authorized to access resources within the VPN based on the set of application policies received from the application policy database (block 406); enabling, by the computing system, the application to access the resources within the VPN when it is determined that the set of application policies authorizes the application to access the resources within the VPN (block 408).

At block 402, the method 400 includes connecting to a virtual private network (VPN). For example, a computing system connects electronically to a VPN by sending authentication credentials. The authentication credentials may include a passkey, a username, a password, a unique identifier, and/or other appropriate authentication information. The authentication credentials are sent to an appropriate authentication device within the VPN such as to a VPN server or other authentication device. The method 400 continues to block 404.

At block 404, the method 400 includes receiving application policies. In one implementation, the computing system receives a set of application policies from an application policy database within the VPN. The VPN may include an application policy database that stores application policies. These application policies may be received and loaded onto the computing system an application policy management device within the VPN. The application policies define which applications may access information and resources within the VPN and which applications are denied such access. In one example, the set of application policies may include a list of applications that are authorized to access the resources within the VPN. In another example, set of application policies may include a list of resources within the VPN and a list of the applications that are authorized to access each of the resources within the VPN. In this way, only certain applications may access certain VPN resources. So while an application may access some VPN resources, it may be denied access to other VPN resources. The method 400 continues to block 406.

At block 406, the method 400 includes determining whether an application is authorized to access VPN resources based on the application policies. In an example, the computing system determines whether an application running on the computing system is authorized to access resources within the VPN based on the set of application policies received from the application policy database. When a user launches an application, or when an application attempts to connect to network resources, the computing system compares the application with the application policies to determine whether the application is approved for access to the VPN resources. If so, the computing system may enable the application to utilize the VPN connection to access the VPN resources, such as at block 408. For example, an enterprise application that requires data stored in the VPN to function may be approved for access in the application policies.

Additional processes also may be included. For example, the method 400 may include preventing the application from accessing VPN resources. This may include preventing, by the computing system, the application from accessing resources within the VPN when it is determined that the set of application policies does not authorize the application to access the resources within the VPN. In this case, the denied application may use general Internet connectivity to perform tasks as appropriate but may not access VPN resources. Such denied applications may be general, consumer applications such as social media applications, personal email applications, and the like. In one example, if an application is not explicitly approved for accessing the VPN in the application policies or if the application policy does not contain an authorization designation for the application, the computing system may deny access to the VPN and its resources for that application, whether the application is listed as a “deny” application or not.

It should be understood that the processes depicted in FIG. 4 represent illustrations, and that other processes may be added or existing processes may be removed, modified, or rearranged without departing from the scope and spirit of the present disclosure.

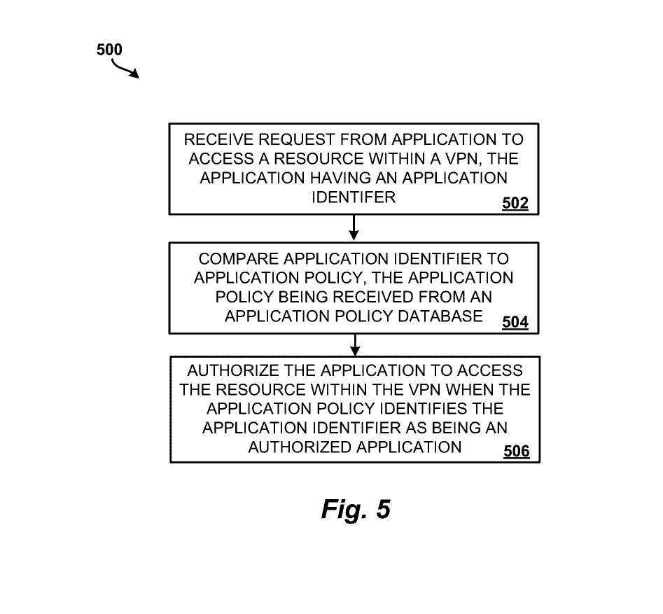

FIG. 5 illustrates a flow diagram of a method 500 for using application policies to authorize application access to a virtual private network resource according to examples of the present disclosure. The method 500 may be executed by a computing system or a computing device such as computing device 102, 202, or 302 of FIGS. 1-3 respectively. In one example, method 500 may include: receiving a request from an application to access a resource within a virtual private network, the application having an application identifier (block 502); comparing the application identifier to an application policy, the application policy being received from an application policy database within the virtual private network (block 504); and authorizing the application to access the resource within the virtual private network when the application policy identifies the application identifier as being an authorized application (block 506).

At block 502, the method 500 includes receiving a request from an application to access a resource with receive a request from an application to access a resource within a virtual private network, the application having an application identifier. The request may originate with the application when the application attempts to access a resource or resources within the virtual private network. Once the request for access occurs, a virtual private network server or other device may request that the device having the application proves it is authorized to access the resource within the virtual private network. At this point, the method 500 then continues to block 504.

At block 504, the method 500 includes comparing the application identifier to an application policy. In one example, the application policy is receivable or received from an application policy database within the virtual private network. In another example, the application policy may be preconfigured or preloaded onto the appropriate device, such as the computing devices discussed herein. Once the application requests access to the resource within the virtual private network, the computing device having the application will compare the application's application identifier to an application policy stored on the device. The application policy is received from an authentication device within the virtual private network, either prior to the application requesting access or at the time the application requests access. In one example, the application policy includes a list of applications that are authorized to access the resource within the virtual private network. In another example, the application policy includes a list of resources within the virtual private network and a list of applications that are authorized to access the resources within the virtual private network. Once the application identifier is compared to the application policy, the method 500 continues to block 506.

At block 506, the method includes authorizing the application to access the resource within the virtual private network when the application policy identifies the application identifier as being an authorized application. For example, the application is allowed access to the virtual private network and its resources when the application's application identifier is indicated as an “allowed” application in the application policy. Otherwise, the application may be denied access, for example.

Additional processes also may be included. For example, the method 500 may include denying the application from accessing the resource within the virtual private network when the application policy does not identify the application identifier as being an authorized application. Similarly, in another example, the method 500 may include deny the application from accessing the resource within the virtual private network when the application policy does not contain the application identifier. In one example, the method 500 may also include connecting electronically to a virtual private network.

It should be understood that the processes depicted in FIG. 5 represent illustrations, and that other processes may be added or existing processes may be removed, modified, or rearranged without departing from the scope and spirit of the present disclosure.

It should be emphasized that the above-described examples are merely possible examples of implementations and set forth for a clear understanding of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such appropriate modifications and variations are intended to be included within the scope of the present disclosure, and all possible claims to individual aspects or combinations of elements or steps are intended to be supported by the present disclosure.

What is claimed is:

1. A non-transitory computer-readable storage medium storing instructions that, when executed by a processor, cause the processor to:
receive a request from an application to access a resource within a virtual private network, the application having an application identifier;
compare the application identifier to an application policy; and
authorize the application to access the resource within the virtual private network when the application policy identifies the application identifier as being an authorized application.

2. The computer-readable storage medium of claim 1, wherein the
deny the application from accessing the resource within the virtual private network when the application policy does not identify the application identifier as being an authorized application.

3. The computer-readable storage medium of claim 1, wherein the instructions further cause the processor to:
deny the application from accessing the resource within the virtual private network when the application policy does not contain the application identifier.

4. The computer-readable storage medium of claim 1, wherein the application policy is receivable from an application policy database within the virtual private network.

5. The computer-readable storage medium of claim 1, wherein the application policy includes a list of applications that are authorized to access the resource within the virtual private network.

6. The computer-readable storage medium of claim 1, wherein the application policy includes a list of resources within the virtual private network and a list of applications that are authorized to access the resources within the virtual private network.

7. A method comprising:
connecting, by a computing system, electronically to a virtual private network (VPN);
receiving, by the computing system, a set of application policies from an application policy database within the VPN;
determining, by the computing system, whether an application running on the computing system is authorized to access resources within the VPN based on the set of application policies received from the application policy database;
enabling, by the computing system, the application to access the resources within the VPN when it is determined that the set of application policies authorizes the application to access the resources within the VPN.

8. The method of claim 7, further comprising:
preventing, by the computing system, the application from accessing resources within the VPN when it is determined that the set of application policies does not authorize the application to access the resources within the VPN.

9. The method of claim 7, further comprising:
preventing, by the computing system, the application from accessing resources within the VPN when it is determined that the set of application policies does not include an authorization designation for the application.

10. The method of claim 7, wherein connecting electronically to the VPN further comprises:
receiving a request for authentication from a VPN device;
transmitting to the VPN device an authentication credential responsive to the request for authentication.

11. The method of claim 7, wherein the set of application policies include a list of applications that are authorized to access the resources within the VPN.

12. The method of claim 7, wherein the set of application policies include a list of resources within the VPN and a list of the applications that are authorized to access the resources within the VPN.

13. The method of claim 7, wherein determining whether an application running on the computing system is authorized to access resources within the VPN includes comparing the application to the application policies to determine whether the application is approved for access to the resources within VPN.

14. A system comprising:
a processing resource;
a memory resource;
a database that stores an application policy;
an application policy administration module executable by the processing resource to generate the application policy to provision access restrictions to a set of applications and enable authorized access to a set of virtual private network resources.

15. The system of claim 14, wherein the set of applications includes an access designation for a corresponding network resource.
